(19) United States
(12) Patent Application Publication
(10) Pub. No.: US 2025/0103428 A1
(43) Pub. Date: Mar. 27, 2025

(54) APPARATUS AND METHOD FOR EFFICIENT ENCODING FOR TRUSTED EXECUTION ENVIRONMENTS WITH FULL ERROR CORRECTION

(71) Applicant: Intel Corporation, Santa Clara, CA (US)

(72) Inventors: SERGEJ DEUTSCH, Hillsboro, OR (US); KARANVIR GREWAL, Hillsboro, OR (US); DAVID M. DURHAM, Hillsboro, OR, 97123, OR (US)

(21) Appl. No.: 18/373,780

(22) Filed: Sep. 27, 2023

(51) Int. Cl. G06F 11/10; G06F 21/64

(52) U.S. Cl. CPC G06F 11/1064; G06F 11/102; G06F 21/64

(57) ABSTRACT

An apparatus and method for efficient encoding for trusted environments including full error correction. One embodiment of a processor comprises: a plurality of cores to execute instructions;

a memory controller coupled to the plurality of cores, the memory controller operable in a first error correction mode and a second error correction mode, the memory controller comprising: a decoder to decode first error correction code (ECC) bits encoded in accordance with the first error correction mode to determine a first syndrome and a second syndrome based on data corresponding to the ECC bits; error detection circuitry to determine whether one or both of the first syndrome and the second syndrome indicates an error in the data; and an encoder to generate second ECC bits in accordance with the second error correction mode, the ECC bits to be encoded based on whether one or both of the first syndrome and the second syndrome indicates an error.

### BACKGROUND

### Field of the Invention

This invention relates generally to the field of computer processors. More particularly, the invention relates to an apparatus and method for efficient encoding for trusted execution environments with full error correction.

### Description of the Related Art

Error-correcting code (ECC) dynamic random access memory (DRAM) modules provide additional storage for in-line error correction. For instance, a typical dual in-line memory module (DIMM) incorporates two ECC devices, allowing for storing of additional 128b bits per 512b cacheline. These bits are read simultaneously with the data, hence there is no impact on bandwidth or latency. Certain security technologies use that storage for in-line security metadata, effectively stealing bits from the error-correcting code. For example, Trust Domain Extensions (TDX) requires one bit of information per cacheline in ECC memory to indicate whether this memory is within the trusted domain. The consequence of stealing bits from ECC is reduced error coverage. For instance, a 10×4 DIMM with one stolen bit from 128b ECC cannot guarantee single-device data correction (SDDC) with 127b of ECC, which is an important feature for server memory.

### BRIEF DESCRIPTION OF THE DRAWINGS

A better understanding of the present invention can be obtained from the following detailed description in conjunction with the following drawings, in which:

FIG. 1 is a diagram of an access control field indicating application of a fixed encoding pattern to ECC bits according to an implementation.

FIG. 2 is a diagram of memory controller processing in an implementation.

FIG. 3 is a diagram of memory controller processing in an implementation.

FIG. 4 is a logic diagram of selecting a fixed encoding pattern in an implementation.

FIG. 5 is a flow diagram of memory controller processing for writing data to a memory according to an implementation.

FIGS. 6A and 6B are flow diagrams of memory controller processing for reading data from a memory according to an implementation.

FIG. 7 is a schematic diagram of an illustrative electronic computing device to perform a method of memory controller processing according to an implementation.

FIG. 8 illustrates a method in accordance with embodiments of the invention.

FIG. 9 illustrates another method in accordance with embodiments of the invention.

FIG. 10 illustrates an apparatus in accordance with embodiments of the invention.

FIG. 11 illustrates a system in accordance with embodiments of the invention.

FIG. 12 illustrates a processor comprising a plurality of cores.

FIG. 13A illustrates a plurality of stages of a processing pipeline.

FIG. 13B illustrates details of one embodiment of a core.

FIG. 14 illustrates execution circuitry in accordance with one embodiment.

FIG. 15 illustrates one embodiment of a register architecture.

FIG. 16 illustrates one example of an instruction format.

FIG. 17 illustrates addressing techniques in accordance with one embodiment.

FIG. 18 illustrates one embodiment of an instruction prefix.

FIGS. 19A-D illustrate embodiments of how the R, X, and B fields of the prefix are used.

FIGS. 20A-B illustrate examples of a second instruction prefix.

FIG. 21 illustrates payload bytes of one embodiment of an instruction prefix.

FIG. 22 illustrates instruction conversion and binary translation implementations.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

Implementations of the disclosure provide efficient security metadata encoding in ECC memory that reduces or eliminates negative impacts to reliability, availability and serviceability (RAS) when used with encoded security metadata of a certain type. An implementation provides 100% SDDC while also determining if the accessed memory is protected for use by a trusted execution environment (TEE), effectively removing the trusted domain (TD) bit dependency, in one example.

Some prior approaches adjusted error correcting code to fit into the reduced space and reduced error coverage, stored non-ECC metadata in sequestered memory, and/or added additional ECC memory devices to store metadata (which is very expensive). The prior approaches suffered from negative impacts to RAS and/or performance (including storing and fetching security metadata from sequestered memory), reduced error coverage, and lost RAS features such as SDDC.

The technology described herein is a solution that instead of using dedicated bits for security metadata (such as a trusted execution environment (TEE) bit, a trusted domain (TD) bit, key identifiers (IDs), memory tags, etc.), combines a specific and selected fixed encoding bit pattern (e.g., using an exclusive-OR (XOR) operation) with the ECC bits based at least in part on the security metadata value to be encoded. On a read request, the fixed encoding pattern is removed (e.g., by application of an XOR operation) based at least in part on the read request's security metadata. If there is a mismatch between the security metadata associated with the read request and the originally encoded security metadata (during a write request), ECC circuitry will detect this condition as an error.

In an implementation, the security metadata is called an access control field herein. The access control field may comprise one or more bits to indicate a security status. The access control field may also be used to select one of a plurality of fixed encoding patterns in one implementation.

The technology described herein is applicable to the types of security metadata bits that are stored in DRAM on cacheline write requests and that are validated on each read request. For example, TDX stores one bit per cacheline, called a TD bit, that is set if the cacheline is within the trusted domain memory. On read requests, the processing core provides a request TD bit, which is set if and only if the request originates from a TD. The request TD bit is then compared with the security metadata bit retrieved from memory. If the bits don't match, that means non-TD software is trying to read TD memory or vice versa. An aspect of this security processing is that the security metadata bit is available on read requests and only needs to be validated.

Other, similar types of security metadata handled in this manner may include cryptographic key IDs, or memory tags in general, that are stored in memory on write requests and are validated on read requests.

An implementation combines ECC bits and the security metadata encoded via fixed encoding patterns, instead of stealing bits from the ECC as in a prior approach.

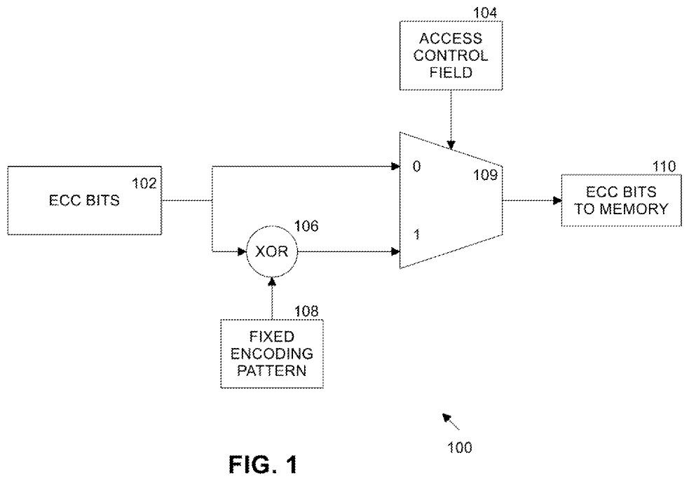

FIG. 1 is a diagram 100 of an access control field 104 indicating application of a fixed encoding pattern 108 to ECC bits 102 (associated with data to be stored in a memory) according to an implementation. During a write operation, when ECC bits 102 are to be stored to a memory, if access control field 104 does not indicate encoding the ECC bits to a multiplexor 109 (e.g., access control field is not set, or 0), then ECC bits 102 are stored in the memory without modification (as ECC bits to memory 110). If access control field 104 does indicate encoding the ECC bits (e.g., when access control field 104 (such as a TEE bit or TD bit, for example) is set or otherwise indicates encoding, or 1), then XOR 106 combines ECC bits 102 with fixed encoding pattern 108 to generate ECC bits to memory 110. The ECC bits to memory 110 is stored in the memory. Fixed encoding pattern 108 comprises a plurality of bits. In an implementation, a number of bits in ECC bits 102 is the same as a number of bits in fixed encoding pattern 108.

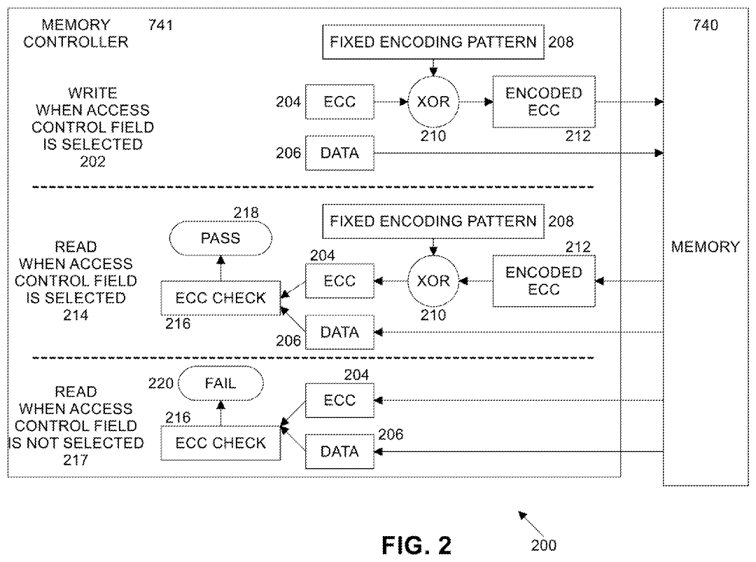

FIG. 2 is a diagram of memory controller 741 processing 200 in an implementation. When access control field 104 is selected (e.g., set) during a write operation 202, ECC 204 is XORed 210 with fixed encoding pattern 208 to generate encoded ECC 212. Encoded ECC 212 is stored along with data 206 in memory 740. Subsequently, when a read request is received to get the data out of memory 740, when access control field 104 is selected during a read operation 214, encoded ECC 212 and data 206 are read from memory 740. Encoded ECC 212 is XORed 210 with fixed encoding pattern 208 to regenerate ECC 204 (effectively removing the fixed encoding pattern from the encoded ECC). ECC check 216 is performed on ECC 204 and data 206. Since the access control field was selected on the prior write operation and is selected on the current read operation (e.g., the write requester and the read requester have the same value for the access control field), the ECC check passes at block 218. When a read request is received to get the data out of memory 740, when access control field 104 is not selected during a read operation 217, ECC 204 and data 206 are read from memory 740, without performing an XOR on the ECC 204. ECC check 216 is performed on ECC 204 and data 206. Since the access control field was selected on the prior write operation and is not on the current read operation (e.g., the write requester and the read requester do not have the same value for the access control field), the ECC check fails at block 220.

If the wrong access control field 104 (e.g., TEE bit) was provided on the read request (e.g., TEE=0), then the fixed encoding pattern is not removed from the ECC and an existing error-correcting process detects this condition as an uncorrectable error with a specific syndrome. This is guaranteed, since ECC is linear, so a fixed encoding pattern 208 will always result in the same syndrome on an access control field (e.g., TEE bit) mismatch, unless there is also an error in memory 740. Thus, access to a TD memory from non-TD software, for example, is detected and reported.

The flow for writes with access control field 104 not selected works in a similar fashion. No fixed encoding pattern is applied on processing of a write request. If the memory is read with the access control field selected, the fixed encoding pattern is mixed into the ECC bits, resulting in an uncorrectable error with a pre-determined syndrome.

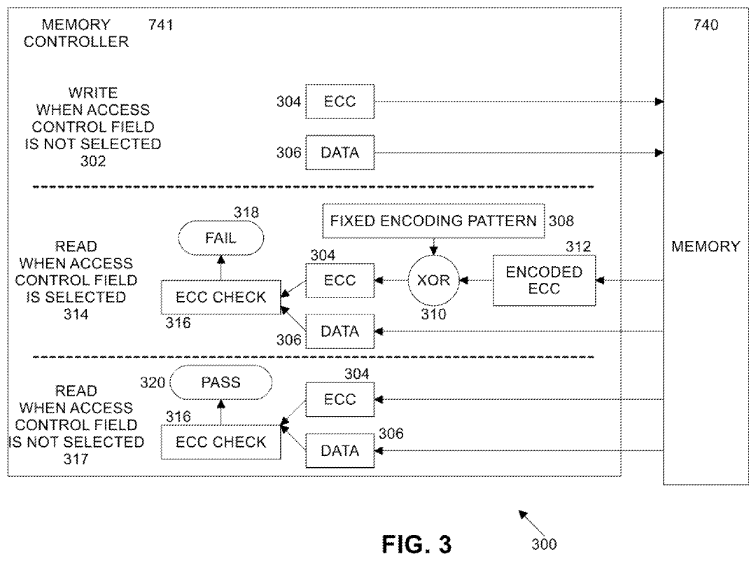

FIG. 3 is a diagram of memory controller 741 processing 300 in an implementation. When access control field 104 is not selected (e.g., not set) during a write operation 302, ECC 304 is stored along with data 306 in memory 704. Subsequently, when a read request is received to get the data out of memory 740, when access control field 104 is selected during a read operation 314, encoded ECC 312 and data 306 are read from memory 740. Encoded ECC 312 is XORed 310 with fixed encoding pattern 308 to regenerate ECC 304 (effectively removing the fixed encoding pattern from the encoded ECC). ECC check 316 is performed on ECC 304 and data 306. Since the access control field was not selected on the prior write operation but is on the current read operation (e.g., the write requester and the read requester do not have the same value for the access control field), the ECC check fails at block 318. When a read request is received to get the data out of memory 740, when access control field 104 is not selected during a read operation 317, ECC 304 and data 306 are read from memory 740, without performing an XOR on the ECC 304. ECC check 316 is performed on ECC 304 and data 306. Since the access control field was not selected on the prior write operation and is not on the current read operation (e.g., the write requester and the read requester have the same value for the access control field), the ECC check passes at block 320.

Error correction is performed independently of the selected fixed encoding pattern. If the access control field matches on a read request, the access control field is automatically removed from the ECC bits, so even if there are errors in data or ECC bits, normal error correction flows will be performed.

In case of an access control field mismatch and an error in memory 740, both the fixed encoding pattern and the error are superimposed on top of the data/ECC bits. If there is no error in the memory and the security metadata (access control field) mismatches, the ECC algorithm will deterministically detect the mismatch as an uncorrectable error with a specific syndrome. If both events happen (access control bit mismatch and error in memory), then this will be likely detected as uncorrectable error, with a small probability of mis-correction.

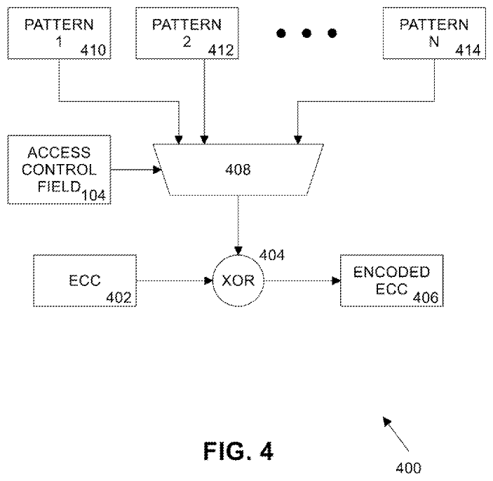

The access control field may comprise one bit of metadata (e.g., a TEE bit) or multiple bits of security metadata. In general, multiple bits of security metadata may be encoded via distinct fixed encoding patterns that may be selected via a multiplexer. FIG. 4 is a logic diagram 400 of selecting a fixed encoding pattern in an implementation. ECC 402 may be XORed 404 with a fixed encoded pattern according to the access control field 104 to generate encoded ECC 406, as described above. However, when access control field 104 comprises multiple values (e.g., multiple bits), in an implementation, access control field 104 may be used to select via multiplexor 408 one of a plurality of fixed encoding patterns, such as pattern 1 410, pattern 2 412, . . . pattern N 414, where N is a natural number, to be XORed 404 with ECC 402.

Each access control field value “m_i” corresponds to a Pattern_i and the multiplexor 408 selects the corresponding fixed encoding pattern based on the access control field value on write requests, as well on read requests. If the data is read with a access control field value m_i that differs from that provided on the write request, the fixed encoding pattern will not be removed from the ECC bits. Instead, the new ECC bits 402 will be equal to the original ECC bits XOR (Pattern_i XOR Pattern_j). The bit patterns need to be chosen such that any combination of mismatched bit patterns “Pattern_i XOR Pattern_j” results in an uncorrectable error, such that any mismatch of access control field bits is detected. By using this method, all ECC bits are preserved and hence there is no impact on the correction capability of the computing system.

When using Reed Solomon codes for error correction, the fixed encoding pattern may alternatively be encoded as a fixed data symbol that is not explicitly stored in memory. This data symbol is determined by the access control field (e.g., TEE bit) input provided by a processor (with the memory access request). If the wrong access control field (e.g., TEE bit) input is provided, the fixed symbol will be wrong and would be corrected by the Reed Solomon code to the correct symbol, showing the error was the incorrect input as provided by the processor (for example, identifying an illegal attempt to access the TEE's protected memory). If an additional memory error is present, the fixed symbol may not be recoverable, but the combination of errors will still result in a detected uncorrectable error with high probability. In this case, the correction logic may additionally test for this condition by setting the TEE fixed data symbol to the alternate value, and then attempting correction of the remaining corrupted data symbols. If correction was possible, then it can be determined that the TEE bit provided by the processor didn't match the expected value for the stored data line, and that the remaining data errors were successfully corrected.

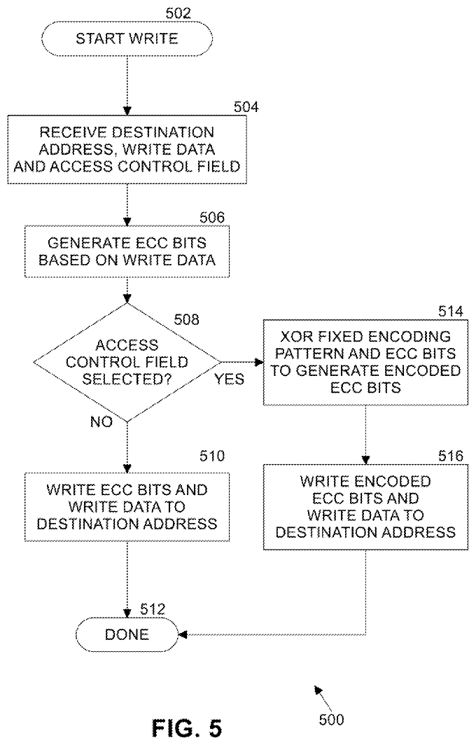

FIG. 5 is a flow diagram of memory controller 741 processing 500 for writing data to a memory 740 according to an implementation. At block 502, write request processing is begun. At block 504, memory controller 741 receives a destination address (e.g., an address in memory 740 to write data), write data, and access control field 104. In an implementation, memory controller 741 receives a write request from a processor 710. At block 506, memory controller 741 generates ECC bits based on the write data. At block 508, if the access control field is selected (e.g., is non-zero (set)), then at block 514 memory controller 741 XOR's a fixed encoding pattern with the ECC bits to generate encoded ECC bits. In an implementation, a specific fixed encoding pattern may be selected from among a plurality of fixed encoding patterns according to the value of the access control field. At block 516, memory controller 741 writes the encoded ECC bits and the write data to the memory starting at the destination address. Write processing is then done at block 512. If at block 508 the access control field is not selected (e.g., is zero (not set)), then at block 510 memory controller 741 writes the ECC bits (unmodified by the fixed encoding pattern) and the write data to the memory starting at the destination address, and write processing is done at block 512.

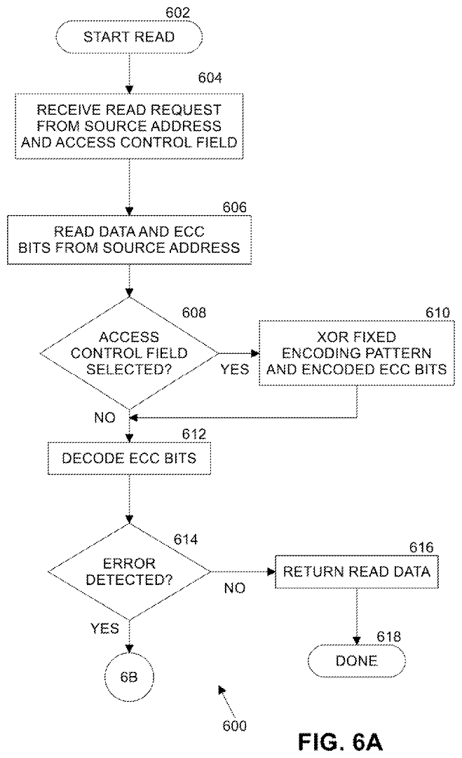

FIGS. 6A and 6B are flow diagrams of memory controller 741 processing 600 for reading data from a memory 740 according to an implementation. At block 602, read processing is begun. At block 604, memory controller 741 receives a read request including a source address (e.g., an address in memory 740 to read data) and access control field 104. In an implementation, memory controller 741 receives a read request from processor 710. At block 606, memory controller 741 reads data and ECC bits from memory 740 starting at the source address. At block 608, if the access control field is selected (e.g., is non-zero (set)), then at block 610 memory controller 741 XORs a fixed encoding pattern and the (previously encoded) ECC bits read from memory 740. Processing continues at block 612. If the access control field is not selected (e.g., is zero (not set)) at block 608, then processing continues directly to block 612. At block 612, memory controller 741 decodes the ECC bits. At block 614, if an error is not detected when decoding the ECC bits, then memory controller 741 returns the read data to the requester (e.g., the processor) at block 616, and read processing is done at block 618.

At block 614, if an error is detected when decoding the ECC bits, read processing continues at block 620 on FIG. 6B via connector 6B. At block 660, if the ECC syndrome is the same as the fixed encoding pattern syndrome, then at block 622 memory controller 741 raises an encoding mismatch exception and read processing is done at block 632. If at block 620, the ECC syndrome is not the same as the fixed encoding pattern syndrome, then at block 624 memory controller 741 attempts to correct the error detected when decoding the ECC bits. At block 626, if correction of the error is successful, memory controller 741 returns the corrected read data to the requester and read processing is done at block 632. Otherwise, memory controller 741 returns an uncorrectable error code to the requester at block 630 and read processing is done at block 632.

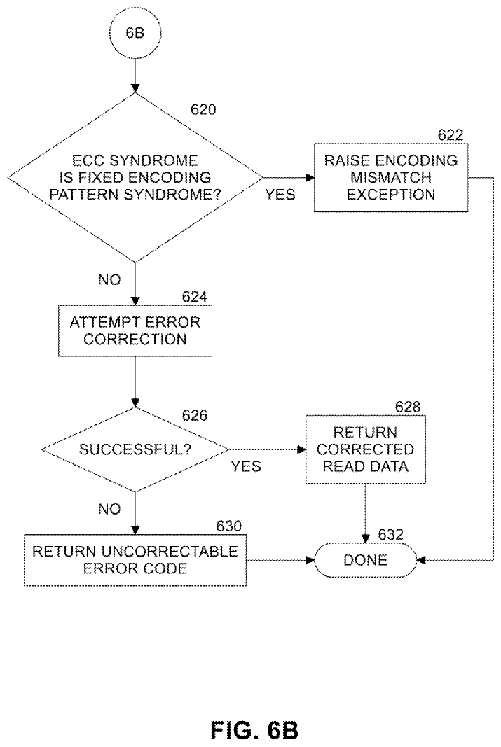

FIG. 7 is a schematic diagram of an illustrative electronic computing device to perform a method of memory controller processing according to an implementation. In some embodiments, the computing device 700 includes one or more processors 710 including one or more processors cores 718 and memory controller 741 to perform ECC encode/decode processing, as described in FIGS. 1-6. In some embodiments, the computing device 700 includes one or more hardware accelerators 768.

In some embodiments, the computing device is to implement ECC encode/decode processing, as described in FIGS. 1-6. The computing device 700 may additionally include one or more of the following: cache 762, a graphical processing unit (GPU) 712 (which may be the hardware accelerator in some implementations), a wireless input/output (I/O) interface 720, a wired I/O interface 730, memory circuitry 740, power management circuitry 750, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, or similar device or system.

In embodiments, the processor cores 718 are capable of executing machine-readable instruction sets 714, reading data and/or instruction sets 714 from one or more storage devices 760 and writing data to the one or more storage devices 760. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 714 may include instructions to implement security ECC encoding/decoding processing, as provided in FIGS. 1-6.

The processor cores 718 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 700 includes a bus or similar communications link 716 that communicably couples and facilitates the exchange of information and/or data between various system components including the processor cores 718, the cache 762, the graphics processor circuitry 712, one or more wireless I/O interfaces 720, one or more wired I/O interfaces 730, one or more storage devices 760, and/or one or more network interfaces 770. The computing device 700 may be referred to in the singular herein, but this is not intended to limit the embodiments to a single computing device 700, since in certain embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAS), and the like. Unless described otherwise, the construction and operation of the various blocks shown in FIG. 7 are of conventional design. Consequently, such blocks need not be described in further detail herein, as they will be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random-access memory (“RAM”) 746. Memory 740 may be managed by memory controller 741. Data and ECC bits may be written to and read from memory 740 by processor 710 using memory controller 741. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include but are not limited to: universal serial bus (USB), IEEE 1394 (“FireWire”), and similar.

The computing device 700 may include one or more communicably coupled, non-transitory, data storage devices 760. The data storage devices 760 may include one or more hard disk drives (HDDs) and/or one or more solid-state storage devices (SSDs). The one or more data storage devices 760 may include any current or future developed storage appliances, network storage devices, and/or systems. Non-limiting examples of such data storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 760 may include one or more removable storage devices, such as one or more flash drives, flash memories, flash storage units, or similar appliances or devices capable of communicable coupling to and decoupling from the computing device 700.

The one or more data storage devices 760 may include interfaces or controllers (not shown) communicatively coupling the respective storage device or system to the bus 716. The one or more data storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interfaces 720 (e.g., Bluetooth®, Near Field Communication or NFC); and/or one or more network interfaces 770 (IEEE 802.3 or Ethernet, IEEE 802.11, or Wi-Fi®, etc.).

Processor-readable instruction sets 714 and other programs, applications, logic sets, and/or modules may be stored in whole or in part in the system memory 740. Such instruction sets 714 may be transferred, in whole or in part, from the one or more data storage devices 760. The instruction sets 714 may be loaded, stored, or otherwise retained in system memory 740, in whole or in part, during execution by the processor cores 718 and/or graphics processor circuitry 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices. In embodiments, the energy storage device 752 may include one or more supercapacitors or ultracapacitors. In embodiments, the power management circuitry 750 may alter, adjust, or control the flow of energy from an external power source 754 to the energy storage device 752 and/or to the computing device 700. The power source 754 may include, but is not limited to, a solar power system, a commercial electric grid, a portable generator, an external energy storage device, or any combination thereof.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 7. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

### Apparatus and Method for Efficient Trusted Execution Bit Encoding with Full Device Correction

As previously described, security technologies which use ECC storage for in-line security metadata effectively steal bits from the error-correcting code. A consequence of stealing bits from ECC is reduced error coverage. The embodiments described above encode the TEE bit via a pattern, such that single-device data correction (SDDC) is still guaranteed. However, without additional provisions, certain errors cannot be corrected if they are detected when transitioning from SDDC mode to Adaptive Double DRAM Device Correction (ADDDC) mode, for which a trusted execution environment (TEE) request bit is not available.

Embodiments of the invention preserve the TEE encoding state when transitioning from SDDC mode to ADDDC, which guarantees full-device correction. If the ECC detects an error in ADDDC mode that cannot be resolved due to a missing TEE bit, the ECC syndrome is encoded into a smaller metadata (e.g., 8 bits) and stored into the available space that frees up in ADDDC mode. The first demand read to that address in ADDDC mode provides the TEE bit, with which the ECC can then resolve the original error prior to ADDDC. This guarantees correction for all single-device errors even if they occur before switching to ADDDC.

The embodiments of the invention are applicable to the types of metadata bits that need to be stored on cacheline writes and that need to be validated on each read. For instance, one bit per cacheline, the TD bit, may be stored. This bit is set if this cacheline is within a portion of memory associated with a trusted domain (TD). On reads, the core provides a “request” TD bit, which is set if and only if the request originates from a TD. This bit is then compared with the metadata bit. If the bits don't match, that means non-TD software is trying to read TD memory or vice versa. Thus, the metadata bit is available on reads and only needs to be validated. Embodiments of the invention can be used with any type of metadata which is stored in memory on writes and needs to be validated on reads (e.g., crypto key IDs, memory tags, etc).

The implementations described above with respect to FIGS. 1-7 superimpose ECC bits and the metadata (e.g., TEE bit) encoded via fixed patterns, instead of stealing bits from the error correcting code. For example, on a write with TEE=1, the TEE pattern is XORed with ECC bits. The resulting encoded ECC bits are written to DRAM along with the data bits. On a read request with TEE=1, the bits retrieved from the ECC memory are XORed with the TEE pattern, effectively removing the TEE pattern from ECC bits. If the wrong TEE bit was provided on request (TEE=0), then the TEE pattern is not removed from ECC and the error-correcting algorithm detects it as an uncorrectable error with a specific syndrome.

However, when the memory controller switches the operational mode from single-device data correction (SDDC) to Adaptive Double DRAM Device Correction mode (ADDDC), the TEE bit is not available. ADDDC is a feature on server processors which is deployed at runtime to dynamically map out the failing DRAM device and continue to provide SDDC ECC coverage on the DIMM, translating to longer DIMM longevity.

Without the TEE bit, certain single-device errors cannot be corrected. For example, an error EA in device A will produce the same ECC syndrome with TEE=0, as some other error EB in a different device B if the TEE bit is 1. If the ECC algorithm encounters such a syndrome, it cannot resolve which device to correct until the TEE bit is available.

The number of such ambiguous cases is relatively small. For instance, in 128b ECC in 10×4 DIMM with one encoded TEE bit, there are 90 such cases, as there are 9*10=90 unique ordered pairs of devices among the total of 10 devices. With an appropriate choice of TEE pattern and encoding parameters (e.g., Reed Solomon (RS) parameters), there are exactly 90 unique syndromes that cannot be resolved without a TEE bit. In the other cases, all single-device errors can be corrected by checking whether the error is correctable with and without using the TEE pattern, and only one case results in a correctable error, whereas the other case is uncorrectable. In the 90 ambiguous cases, both TEE=0 and TEE=1 return “correctable”, which cannot be resolved without the TEE bit, which is supplied on a demand read but not when the MC switches to ADDDC mode. It is important to note that this does not depend on the data, since ECC is linear and data-independent. So, if a specific ambiguous syndrome is encountered, it must be either error EA in device A (if TEE was 0) or error EB in device B (if TEE was 1). The values of EA and EB, as well as the ambiguous syndromes are static and determined only by ECC parameters, such as RS parameters and the TEE pattern, which are known at design time.

Embodiments of the invention postpone the correction of the ambiguous cases until the next demand read, which will supply the TEE bit. This means that the ECC mechanism will not attempt a correction if it detects one of the “special” syndromes during the transition to ADDDC. Instead, it will store the syndrome in a compact form and defer the correction. In the 128b ECC example above with 90 ambiguous syndromes, only 8 bits of storage per cacheline are needed to encode which of the 90 special syndromes was detected when switching to ADDDC. In a practical example, the first four bits can store the index of the device that needs to be corrected if TEE=0, and the other four bits store the index of the device that needs to be corrected if TEE=1. The common case of no error also needs to be encoded (or errors were corrected) when switching to ADDDC, for which all zeros or all ones can be used, for example. Obviously, this requires additional 8 bits of ECC storage per ECC word (i.e., cacheline). For this, additional freed up ECC space is used due to ADDDC mode. For example, in SDDC mode in 10×4, each cacheline is split into two independent units, each of which is split across 10 devices (8 devices×32b of data+2 devices×32b of ECC). When switching to ADDDC mode due to a device failure in one rank, the cacheline is treated as one ECC unit split across 9+10=19 intact devices on both ranks: 16 devices×32b of data+2 devices×32b ECC, which leaves one device free to store up to 32b of metadata per cacheline. An additional 8 bits of that metadata is used for the encoded syndrome.

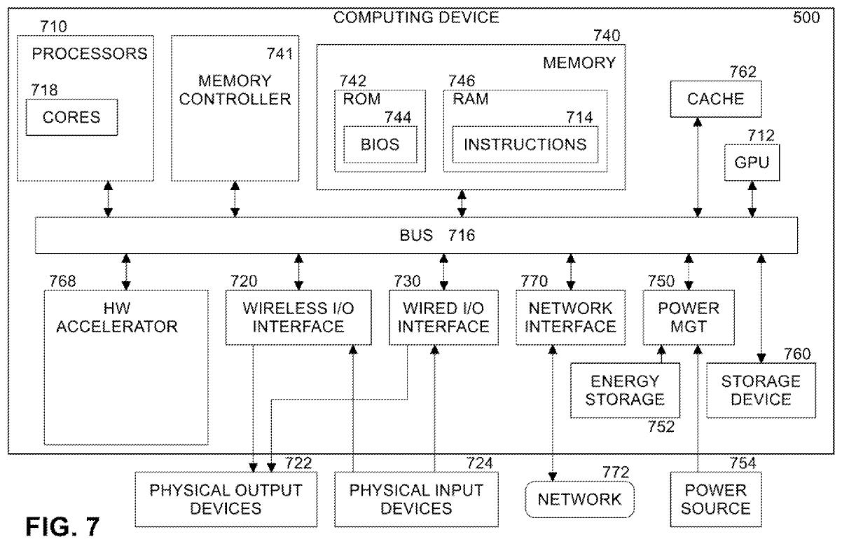

FIG. 8 illustrates a method in accordance with one embodiment of the invention for re-encoding flow when changing from SDDC to ADDDC mode. The cachelines may be read in pairs from both rank 0 and rank 1, reencoded and split over both ranks. As in a normal read case, the SDDC-ECC algorithm generates the syndrome S₀ based on data+ECC bits read, assuming TEE=0. The syndrome S₁ for TEE=1 is generated as an XOR of S₀ and an encoding pattern, such as the fixed encoding patterns described above (e.g., 108, 208, 308, 410-414).

At 801, the SDDC-ECC word is read from DRAM. The cachelines may be read in pairs from both rank 0 and rank 1, re-encoded and split over both ranks. As in a normal read case, at 802, the SDDC-ECC mechanism generates the syndrome S₀ based on data and ECC bits read, assuming TEE=0. The syndrome S₁ for TEE=1 is generated as an XOR of S₀ and the fixed encoding pattern (sometimes referred to as “TEE_PATTERN”).

In this embodiment, if either S₀ or S₁ indicates no error (e.g., are zero), determined at 803, then at 804, the TEE bit is decoded as 0 if S₀==0; otherwise the TEE bit is decoded as 1. If an error is indicated at 803, then if both S₀ and S₁ indicate an uncorrectable error (NE₀ and DUE₀ or NE₁ and DUE₁), determined at 805, this means that the cacheline cannot be corrected even if the TEE bit was available, so the cacheline is poisoned at 806 with a poison pattern and/or a metadata poison bit. If either S₀ or S₁ indicates a correctable error, determined at 809, correction is performed using that syndrome where the TEE bit is decoded as 0 if S₀ indicates a correctable error; otherwise the TEE bit is decoded as 1. At 807, the ADDDC-ECC bits are generated over the data and metadata and the data, metadata, and ECC bits are written across rank 0 and rank 1 at 808.

If both S₀ and S₁ indicate a correctable error (i.e., the result of operation 809 is No), this is a case that would be correctable if the TEE bit was available to resolve the ambiguity. Embodiments of the invention postpone this operation to a demand read in ADDDC mode instead of poisoning the line and losing the data. In one embodiment, the syndrome is encoded at 810 using 8 bits which are stored as metadata. As mentioned above, the first four bits can store the index of the device that needs to be corrected if TEE=0, and the other four bits store the index of the device that needs to be corrected if TEE=1

Thus, in all cases other than both S₀ and S₁ indicating a correctable error (operation 810), the encoded syndrome is set to a special value to distinguish it from a valid encoded syndrome used for operation 810. This value can be all zeros or all ones, for example. Before writing the data back to DRAM across rank 0 and rank 1 in operation 808, new ADDDC-ECC bits are generated at 807 and stored together with the data and metadata (poison bit, encoded syndrome).

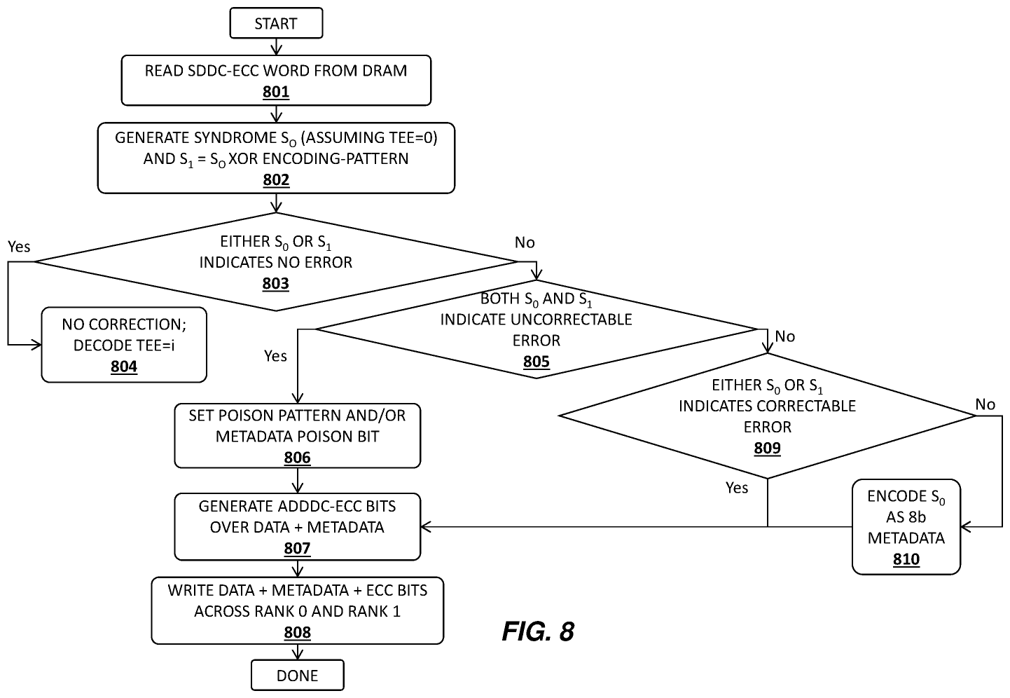

FIG. 9 illustrates a sequence of operations for an AADDC read in accordance with some embodiments of the invention. The illustrated ADDDC read flow starts at 901 reading the EDDDC-ECC word from both ranks. At 902, the ECC word that was generated with the ADDDC ECC mechanism is decoded to correct potential errors that occurred in ADDDC mode. The flow is then enhanced at 903 to check if the encoded syndrome is set to a valid encoded value (for example, is not zero), which indicates that there was an unresolved error prior to ADDDC mode which can now be corrected since the TEE bit is available.

At 904, the encoded syndrome S is “decompressed” (e.g., using a lookup table with 90 entries). If TEE=1, the encoded syndrome S is XORed with the TEE pattern. At 905, the resulting syndrome is then used to perform error correction with the SDDC mechanism. In case errors were corrected (either with ADDDC-ECC or SDDDC-ECC), or there was an uncorrectable error, the state of DRAM is updated accordingly at 906, as in a conventional read flow, and the data is returned to the CPU at 907.

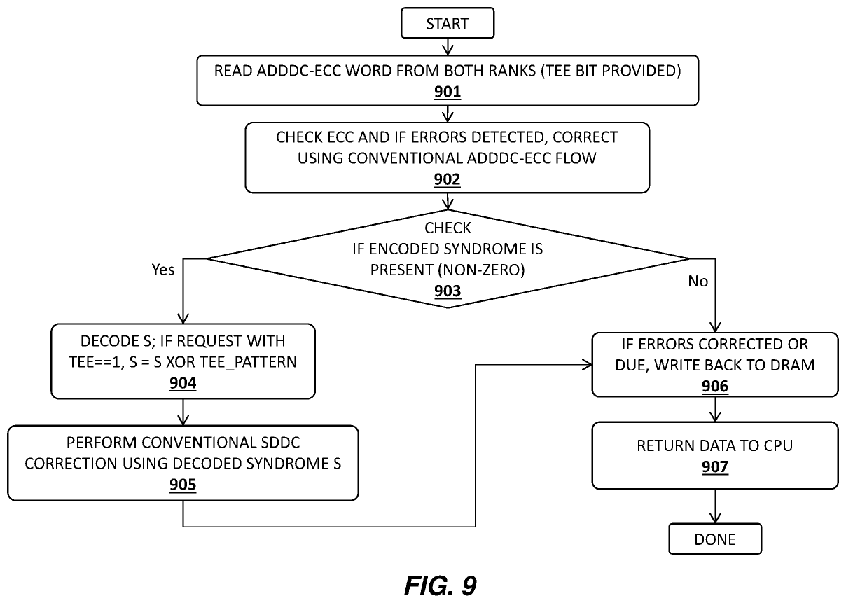

FIG. 10 illustrates a memory controller in accordance with some embodiments of the invention. Decoder circuitry 1001 generates syndrome S₀ based on data and ECC bits read, assuming TEE=0 and generates syndrome S₁ for TEE=1 (e.g., with an XOR of S₀ and the TEE_PATTERN). Error detection circuitry 1005 determines whether S₀ and S₁ indicate correctable errors, uncorrectable errors, or no errors. If either S₀ or S₁ indicates no error (are zero), then the TEE bit is decoded as 0 if S₀==0; otherwise the TEE bit is decoded as 1.

If an error is indicated, then if both S₀ and S₁ indicate an uncorrectable error (NE₀ and DUE₀ or NE₁ and DUE₁), this means that the cacheline cannot be corrected even if the TEE bit was available. Thus, code generation circuitry 1010 poisons the cacheline with a poison pattern and/or a metadata poison bit. If either S₀ or S₁ indicates a correctable error, correction is performed using that syndrome where the TEE bit is decoded as 0 if S₀ indicates a correctable error; otherwise the TEE bit is decoded as 1. Code generation circuitry 1010 generates ADDDC-ECC bits over the data and metadata and ECC bits are written across rank 0 and rank 1 in the memory 901.

If both S₀ and S₁ indicate a correctable error, this is a case that would be correctable if the TEE bit was available to resolve the ambiguity. Embodiments of the invention postpone this operation to a demand read in ADDDC mode instead of poisoning the cacheline and losing the data. In one embodiment, the syndrome is encoded at using 8 bits which are stored as metadata.

Flowcharts representative of example hardware logic, machine readable instructions, hardware implemented state machines, and/or any combination thereof for implementing the memory controller 741 and associated techniques described with respect to FIGS. 1-10. The machine-readable instructions may be one or more executable programs or portion(s) of an executable program for execution by a computer processor such as the processor 710 shown in the example computing device 700 discussed above in connection with FIG. 7. The program may be embodied in software stored on a non-transitory computer readable storage medium such as a CD-ROM, a floppy disk, a hard drive, a DVD, a Blu-ray disk, or a memory associated with the processor 710, but the entire program and/or parts thereof could alternatively be executed by a device other than the processor 710 and/or embodied in firmware or dedicated hardware. Further, although the example program is described with reference to the flowchart illustrated in FIGS. 1-10, many other methods of implementing the example systems 700 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine readable instructions and/or program(s) regardless of the particular format or state of the machine readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example process of FIGS. 1-10 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

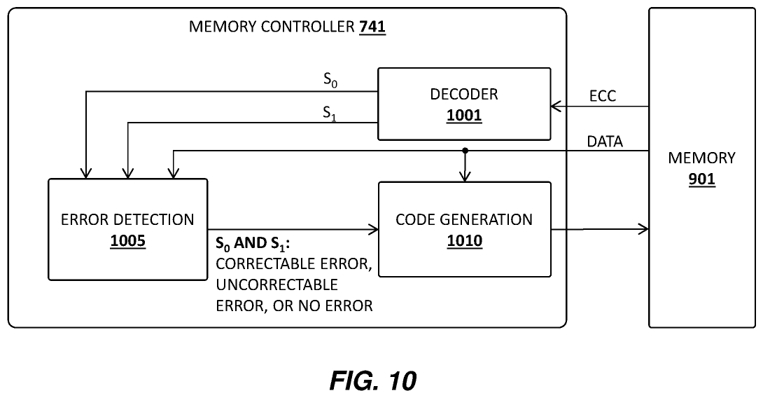

FIG. 11 illustrates embodiments of an exemplary system. Multiprocessor system 1100 is a point-to-point interconnect system and includes a plurality of processors including a first processor 1170 and a second processor 1180 coupled via a point-to-point interconnect 1150. In some embodiments, the first processor 1170 and the second processor 1180 are homogeneous. In some embodiments, first processor 1170 and the second processor 1180 are heterogenous.

Processors 1170 and 1180 are shown including integrated memory controller (IMC) units circuitry 1172 and 1182, respectively. Processor 1170 also includes as part of its interconnect controller units point-to-point (P-P) interfaces 1176 and 1178; similarly, second processor 1180 includes P-P interfaces 1186 and 1188. Processors 1170, 1180 may exchange information via the point-to-point (P-P) interconnect 1150 using P-P interface circuits 1178, 1188. IMCs 1172 and 1182 couple the processors 1170, 1180 to respective memories, namely a memory 1132 and a memory 1134, which may be portions of main memory locally attached to the respective processors.

Processors 1170, 1180 may each exchange information with a chipset 1190 via individual P-P interconnects 1152, 1154 using point to point interface circuits 1176, 1194, 1186, 1198. Chipset 1190 may optionally exchange information with a coprocessor 1138 via a high-performance interface 1192. In some embodiments, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor 1170, 1180 or outside of both processors, yet connected with the processors via P-P interconnect, such that either or both processors' local cache information may be stored in the shared cache if a processor is placed into a low power mode.

Chipset 1190 may be coupled to a first interconnect 1116 via an interface 1196. In some embodiments, first interconnect 1116 may be a Peripheral Component Interconnect (PCI) interconnect, or an interconnect such as a PCI Express interconnect or another I/O interconnect. In some embodiments, one of the interconnects couples to a power control unit (PCU) 1117, which may include circuitry, software, and/or firmware to perform power management operations with regard to the processors 1170, 1180 and/or co-processor 1138. PCU 1117 provides control information to a voltage regulator to cause the voltage regulator to generate the appropriate regulated voltage. PCU 1117 also provides control information to control the operating voltage generated. In various embodiments, PCU 1117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1117 is illustrated as being present as logic separate from the processor 1170 and/or processor 1180. In other cases, PCU 1117 may execute on a given one or more of cores (not shown) of processor 1170 or 1180. In some cases, PCU 1117 may be implemented as a microcontroller (dedicated or general-purpose) or other control logic configured to execute its own dedicated power management code, sometimes referred to as P-code. In yet other embodiments, power management operations to be performed by PCU 1117 may be implemented externally to a processor, such as by way of a separate power management integrated circuit (PMIC) or another component external to the processor. In yet other embodiments, power management operations to be performed by PCU 1117 may be implemented within BIOS or other system software.

Various I/O devices 1114 may be coupled to first interconnect 1116, along with an interconnect (bus) bridge 1118 which couples first interconnect 1116 to a second interconnect 1120. In some embodiments, one or more additional processor(s) 1115, such as coprocessors, high-throughput MIC processors, GPGPU's, accelerators (such as, e.g., graphics accelerators or digital signal processing (DSP) units), field programmable gate arrays (FPGAS), or any other processor, are coupled to first interconnect 1116. In some embodiments, second interconnect 1120 may be a low pin count (LPC) interconnect. Various devices may be coupled to second interconnect 1120 including, for example, a keyboard and/or mouse 1122, communication devices 1127 and a storage unit circuitry 1128. Storage unit circuitry 1128 may be a disk drive or other mass storage device which may include instructions/code and data 1130, in some embodiments. Further, an audio I/O 1124 may be coupled to second interconnect 1120. Note that other architectures than the point-to-point architecture described above are possible. For example, instead of the point-to-point architecture, a system such as multiprocessor system 1100 may implement a multi-drop interconnect or other such architecture.

### Exemplary Core, Processor, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

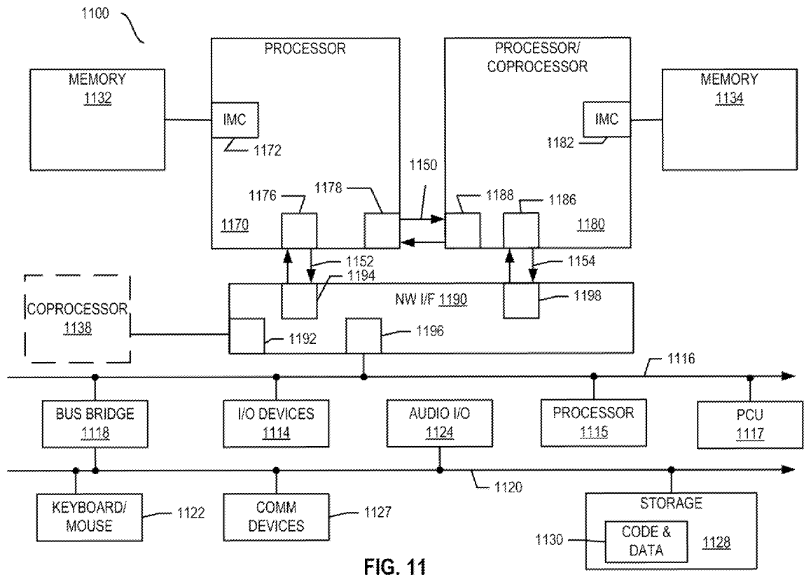

FIG. 12 illustrates a block diagram of embodiments of a processor 1200 that may have more than one core, may have an integrated memory controller, and may have integrated graphics. The solid lined boxes illustrate a processor 1200 with a single core 1202A, a system agent 1210, a set of one or more interconnect controller units circuitry 1216, while the optional addition of the dashed lined boxes illustrates an alternative processor 1200 with multiple cores 1202(A)-(N), a set of one or more integrated memory controller unit(s) circuitry 1214 in the system agent unit circuitry 1210, and special purpose logic 1208, as well as a set of one or more interconnect controller units circuitry 1216. Note that the processor 1200 may be one of the processors 1170 or 1180, or co-processor 1138 or 1115 of FIG. 11.

Thus, different implementations of the processor 1200 may include: 1) a CPU with the special purpose logic 1208 being integrated graphics and/or scientific (throughput) logic (which may include one or more cores, not shown), and the cores 1202(A)-(N) being one or more general purpose cores (e.g., general purpose in-order cores, general purpose out-of-order cores, or a combination of the two); 2) a coprocessor with the cores 1202(A)-(N) being a large number of special purpose cores intended primarily for graphics and/or scientific (throughput); and 3) a coprocessor with the cores 1202(A)-(N) being a large number of general purpose in-order cores. Thus, the processor 1200 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1200 may be a part of and/or may be implemented on one or more substrates using any of a number of process technologies, such as, for example, BiCMOS, CMOS, or NMOS.

A memory hierarchy includes one or more levels of cache unit(s) circuitry 1204(A)-(N) within the cores 1202(A)-(N), a set of one or more shared cache units circuitry 1206, and external memory (not shown) coupled to the set of integrated memory controller units circuitry 1214. The set of one or more shared cache units circuitry 1206 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 1212 interconnects the special purpose logic 1208 (e.g., integrated graphics logic), the set of shared cache units circuitry 1206, and the system agent unit circuitry 1210, alternative embodiments use any number of well-known techniques for interconnecting such units. In some embodiments, coherency is maintained between one or more of the shared cache units circuitry 1206 and cores 1202(A)-(N).

In some embodiments, one or more of the cores 1202(A)-(N) are capable of multi-threading. The system agent unit circuitry 1210 includes those components coordinating and operating cores 1202(A)-(N). The system agent unit circuitry 1210 may include, for example, power control unit (PCU) circuitry and/or display unit circuitry (not shown). The PCU may be or may include logic and components needed for regulating the power state of the cores 1202(A)-(N) and/or the special purpose logic 1208 (e.g., integrated graphics logic). The display unit circuitry is for driving one or more externally connected displays.

The cores 1202(A)-(N) may be homogenous or heterogeneous in terms of architecture instruction set; that is, two or more of the cores 1202(A)-(N) may be capable of executing the same instruction set, while other cores may be capable of executing only a subset of that instruction set or a different instruction set.

### Exemplary Core Architectures

### In-Order and Out-of-Order Core Block Diagram

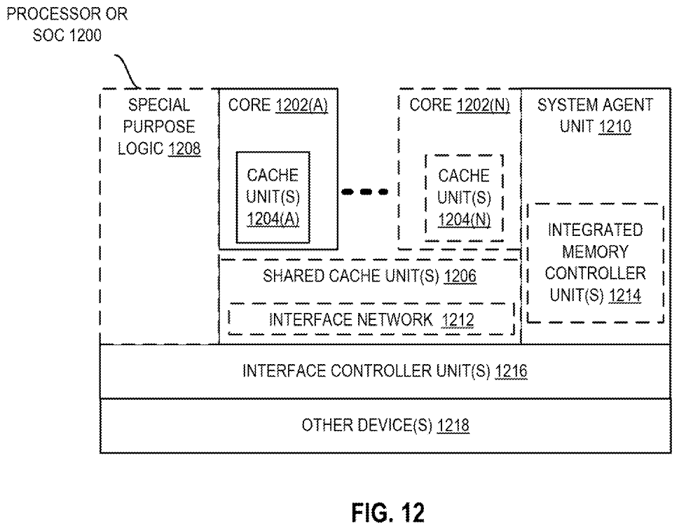

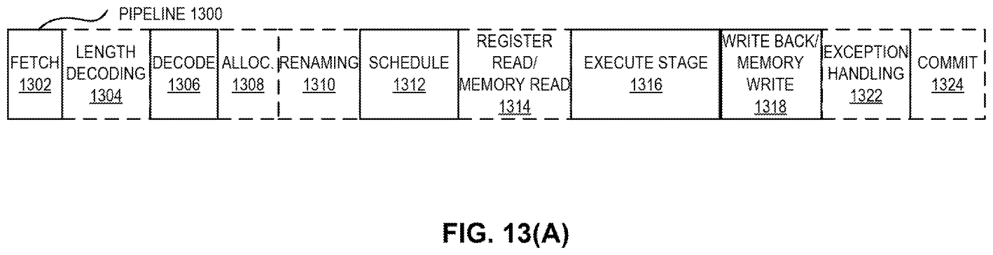

FIG. 13(A) is a block diagram illustrating both an exemplary in-order pipeline and an exemplary register renaming, out-of-order issue/execution pipeline according to embodiments of the invention. FIG. 13(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 13(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 13(A), a processor pipeline 1300 includes a fetch stage 1302, an optional length decode stage 1304, a decode stage 1306, an optional allocation stage 1308, an optional renaming stage 1310, a scheduling (also known as a dispatch or issue) stage 1312, an optional register read/memory read stage 1314, an execute stage 1316, a write back/memory write stage 1318, an optional exception handling stage 1322, and an optional commit stage 1324. One or more operations can be performed in each of these processor pipeline stages. For example, during the fetch stage 1302, one or more instructions are fetched from instruction memory, during the decode stage 1306, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 1306 and the register read/memory read stage 1314 may be combined into one pipeline stage. In one embodiment, during the execute stage 1316, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 1300 as follows: 1) the instruction fetch 1338 performs the fetch and length decoding stages 1302 and 1304; 2) the decode unit circuitry 1340 performs the decode stage 1306; 3) the rename/allocator unit circuitry 1352 performs the allocation stage 1308 and renaming stage 1310; 4) the scheduler unit(s) circuitry 1356 performs the schedule stage 1312; 5) the physical register file(s) unit(s) circuitry 1358 and the memory unit circuitry 1370 perform the register read/memory read stage 1314; the execution cluster 1360 perform the execute stage 1316; 6) the memory unit circuitry 1370 and the physical register file(s) unit(s) circuitry 1358 perform the write back/memory write stage 1318; 7) various units (unit circuitry) may be involved in the exception handling stage 1322; and 8) the retirement unit circuitry 1354 and the physical register file(s) unit(s) circuitry 1358 perform the commit stage 1324.

FIG. 13(B) shows processor core 1390 including front-end unit circuitry 1330 coupled to an execution engine unit circuitry 1350, and both are coupled to a memory unit circuitry 1370. The core 1390 may be a reduced instruction set computing (RISC) core, a complex instruction set computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front end unit circuitry 1330 may include branch prediction unit circuitry 1332 coupled to an instruction cache unit circuitry 1334, which is coupled to an instruction translation lookaside buffer (TLB) 1336, which is coupled to instruction fetch unit circuitry 1338, which is coupled to decode unit circuitry 1340. In one embodiment, the instruction cache unit circuitry 1334 is included in the memory unit circuitry 1370 rather than the front-end unit circuitry 1330. The decode unit circuitry 1340 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 1340 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 1340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1390 includes a microcode ROM (not shown) or other medium that stores microcode for certain macroinstructions (e.g., in decode unit circuitry 1340 or otherwise within the front end unit circuitry 1330). In one embodiment, the decode unit circuitry 1340 includes a micro-operation (micro-op) or operation cache (not shown) to hold/cache decoded operations, micro-tags, or micro-operations generated during the decode or other stages of the processor pipeline 1300. The decode unit circuitry 1340 may be coupled to rename/allocator unit circuitry 1352 in the execution engine unit circuitry 1350.

The execution engine circuitry 1350 includes the rename/allocator unit circuitry 1352 coupled to a retirement unit circuitry 1354 and a set of one or more scheduler(s) circuitry 1356. The scheduler(s) circuitry 1356 represents any number of different schedulers, including reservations stations, central instruction window, etc. In some embodiments, the scheduler(s) circuitry 1356 can include arithmetic logic unit (ALU) scheduler/scheduling circuitry, ALU queues, arithmetic generation unit (AGU) scheduler/scheduling circuitry, AGU queues, etc. The scheduler(s) circuitry 1356 is coupled to the physical register file(s) circuitry 1358. Each of the physical register file(s) circuitry 1358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 1358 includes vector registers unit circuitry, writemask registers unit circuitry, and scalar register unit circuitry. These register units may provide architectural vector registers, vector mask registers, general-purpose registers, etc. The physical register file(s) unit(s) circuitry 1358 is overlapped by the retirement unit circuitry 1354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1354 and the physical register file(s) circuitry 1358 are coupled to the execution cluster(s) 1360. The execution cluster(s) 1360 includes a set of one or more execution units circuitry 1362 and a set of one or more memory access circuitry 1364. The execution units circuitry 1362 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 1356, physical register file(s) unit(s) circuitry 1358, and execution cluster(s) 1360 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 1364). It should also be understood that where separate pipelines are used, one or more of these pipelines may be out-of-order issue/execution and the rest in-order.

In some embodiments, the execution engine unit circuitry 1350 may perform load store unit (LSU) address/data pipelining to an Advanced Microcontroller Bus (AHB) interface (not shown), and address phase and writeback, data phase load, store, and branches.

The set of memory access circuitry 1364 is coupled to the memory unit circuitry 1370, which includes data TLB unit circuitry 1372 coupled to a data cache circuitry 1374 coupled to a level 2 (L2) cache circuitry 1376. In one exemplary embodiment, the memory access units circuitry 1364 may include a load unit circuitry, a store address unit circuit, and a store data unit circuitry, each of which is coupled to the data TLB circuitry 1372 in the memory unit circuitry 1370. The instruction cache circuitry 1334 is further coupled to a level 2 (L2) cache unit circuitry 1376 in the memory unit circuitry 1370. In one embodiment, the instruction cache 1334 and the data cache 1374 are combined into a single instruction and data cache (not shown) in L2 cache unit circuitry 1376, a level 3 (L3) cache unit circuitry (not shown), and/or main memory. The L2 cache unit circuitry 1376 is coupled to one or more other levels of cache and eventually to a main memory.

The core 1390 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 1390 includes logic to support a packed data instruction set extension (e.g., AVX1, AVX2), thereby allowing the operations used by many multimedia applications to be performed using packed data.

### Exemplary Execution Unit(s) Circuitry

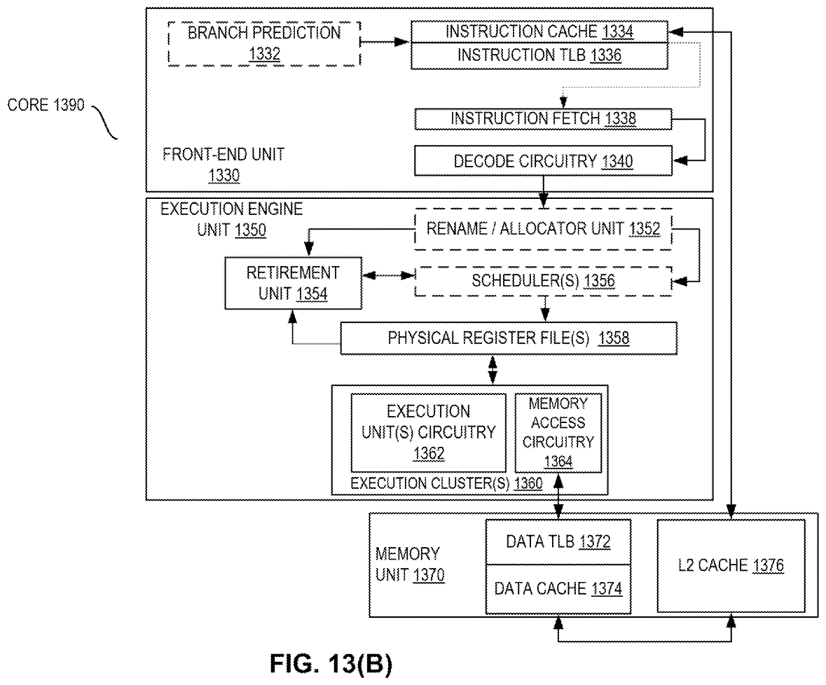

FIG. 14 illustrates embodiments of execution unit(s) circuitry, such as execution unit(s) circuitry 1362 of FIG. 13(B). As illustrated, execution unit(s) circuitry 1362 may include one or more ALU circuits 1401, vector/SIMD unit circuits 1403, load/store unit circuits 1405, and/or branch/jump unit circuits 1407. ALU circuits 1401 perform integer arithmetic and/or Boolean operations. Vector/SIMD unit circuits 1403 perform vector/SIMD operations on packed data (such as SIMD/vector registers). Load/store unit circuits 1405 execute load and store instructions to load data from memory into registers or store from registers to memory. Load/store unit circuits 1405 may also generate addresses. Branch/jump unit circuits 1407 cause a branch or jump to a memory address depending on the instruction. Floating-point unit (FPU) circuits 1409 perform floating-point arithmetic. The width of the execution unit(s) circuitry 1362 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

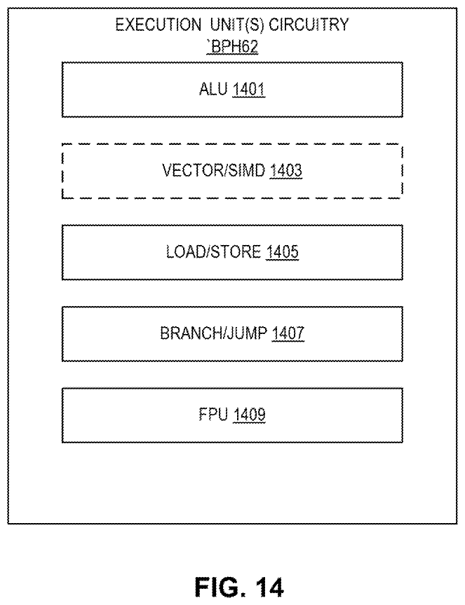

FIG. 15 is a block diagram of a register architecture 1500 according to some embodiments. As illustrated, there are vector/SIMD registers 1510 that vary from 128-bit to 1,024 bits width. In some embodiments, the vector/SIMD registers 1510 are physically 512-bits and, depending upon the mapping, only some of the lower bits are used. For example, in some embodiments, the vector/SIMD registers 1510 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 1500 includes writemask/predicate registers 1515. For example, in some embodiments, there are 8 writemask/predicate registers (sometimes called k0 through k7) that are each 16-bit, 32-bit, 64-bit, or 128-bit in size. Writemask/predicate registers 1515 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 1515 corresponds to a data element position of the destination. In other embodiments, the writemask/predicate registers 1515 are scalable and consists of a set number of enable bits for a given vector element (e.g., 8 enable bits per 64-bit vector element).

The register architecture 1500 includes a plurality of general-purpose registers 1525. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 1500 includes scalar floating-point register 1545 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 1540 (e.g., EFLAGS, RFLAGS, etc.) store status and control information for arithmetic, compare, and system operations. For example, the one or more flag registers 1540 may store condition code information such as carry, parity, auxiliary carry, zero, sign, and overflow. In some embodiments, the one or more flag registers 1540 are called program status and control registers.

Segment registers 1520 contain segment points for use in accessing memory. In some embodiments, these registers are referenced by the names CS, DS, SS, ES, FS, and GS.

Machine specific registers (MSRs) 1535 control and report on processor performance. Most MSRs 1535 handle system-related functions and are not accessible to an application program. Machine check registers 1560 consist of control, status, and error reporting MSRs that are used to detect and report on hardware errors.

One or more instruction pointer register(s) 1530 store an instruction pointer value. Control register(s) 1555 (e.g., CR0-CR4) determine the operating mode of a processor (e.g., processor 1170, 1180, 1138, 1115, and/or 1200) and the characteristics of a currently executing task. Debug registers 1550 control and allow for the monitoring of a processor or core's debugging operations.

Memory management registers 1565 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

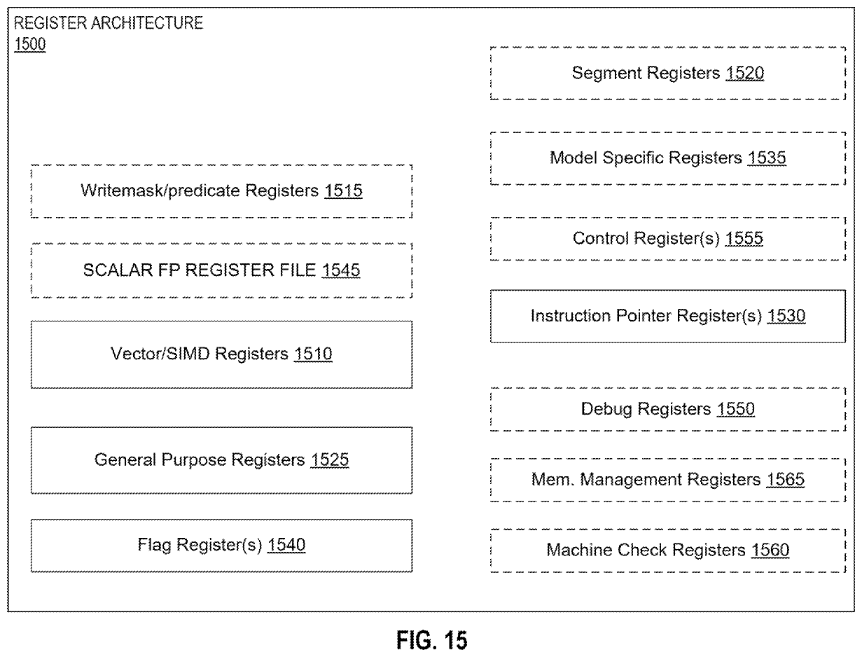

FIG. 16 illustrates embodiments of an instruction format. As illustrated, an instruction may include multiple components including, but not limited to, one or more fields for: one or more prefixes 1601, an opcode 1603, addressing information 1605 (e.g., register identifiers, memory addressing information, etc.), a displacement value 1607, and/or an immediate 1609. Note that some instructions utilize some or all of the fields of the format whereas others may only use the field for the opcode 1603. In some embodiments, the order illustrated is the order in which these fields are to be encoded, however, it should be appreciated that in other embodiments these fields may be encoded in a different order, combined, etc.

The prefix(es) field(s) 1601, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1603 is used to at least partially define the operation to be performed upon a decoding of the instruction. In some embodiments, a primary opcode encoded in the opcode field 1603 is 1, 2, or 3 bytes in length. In other embodiments, a primary opcode can be a different length. An additional 3-bit opcode field is sometimes encoded in another field.

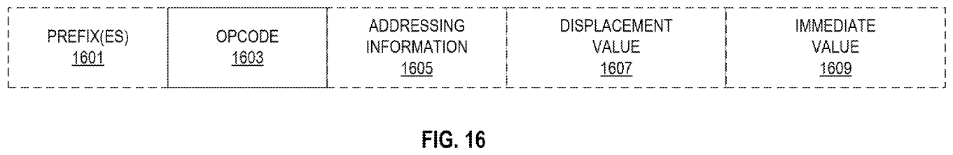

The addressing field 1605 is used to address one or more operands of the instruction, such as a location in memory or one or more registers. FIG. 17 illustrates embodiments of the addressing field 1605. In this illustration, an optional ModR/M byte 1702 and an optional Scale, Index, Base (SIB) byte 1704 are shown. The ModR/M byte 1702 and the SIB byte 1704 are used to encode up to two operands of an instruction, each of which is a direct register or effective memory address. Note that each of these fields are optional in that not all instructions include one or more of these fields. The MOD R/M byte 1702 includes a MOD field 1742, a register field 1744, and R/M field 1746.

The content of the MOD field 1742 distinguishes between memory access and non-memory access modes. In some embodiments, when the MOD field 1742 has a value of b11, a register-direct addressing mode is utilized, and otherwise register-indirect addressing is used.

The register field 1744 may encode either the destination register operand or a source register operand, or may encode an opcode extension and not be used to encode any instruction operand. The content of register index field 1744, directly or through address generation, specifies the locations of a source or destination operand (either in a register or in memory). In some embodiments, the register field 1744 is supplemented with an additional bit from a prefix (e.g., prefix 1601) to allow for greater addressing.

The R/M field 1746 may be used to encode an instruction operand that references a memory address, or may be used to encode either the destination register operand or a source register operand. Note the R/M field 1746 may be combined with the MOD field 1742 to dictate an addressing mode in some embodiments.

The SIB byte 1704 includes a scale field 1752, an index field 1754, and a base field 1756 to be used in the generation of an address. The scale field 1752 indicates scaling factor. The index field 1754 specifies an index register to use. In some embodiments, the index field 1754 is supplemented with an additional bit from a prefix (e.g., prefix 601) to allow for greater addressing. The base field 1756 specifies a base register to use. In some embodiments, the base field 1756 is supplemented with an additional bit from a prefix (e.g., prefix 1601) to allow for greater addressing. In practice, the content of the scale field 1752 allows for the scaling of the content of the index field 1754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 1607 provides this value. Additionally, in some embodiments, a displacement factor usage is encoded in the MOD field of the addressing field 605 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 1607.

In some embodiments, an immediate field 1609 specifies an immediate for the instruction. An immediate may be encoded as a 1-byte value, a 2-byte value, a 4-byte value, etc.

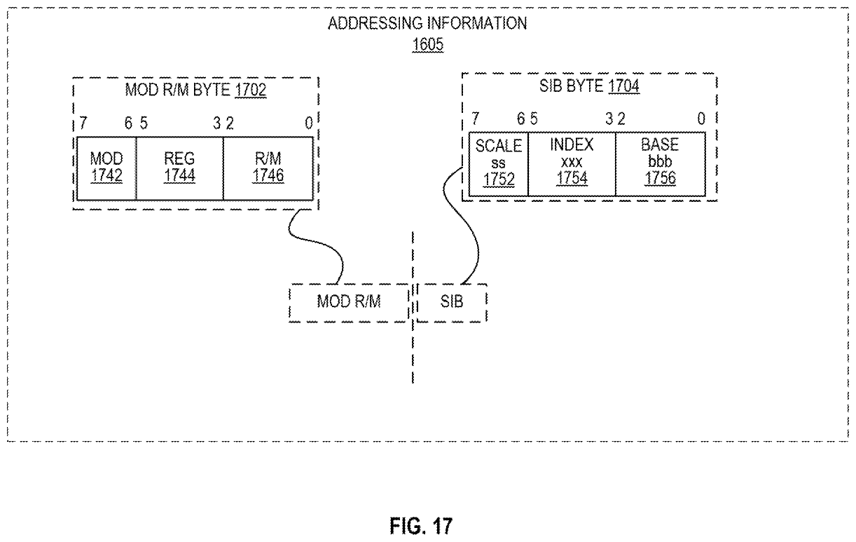

FIG. 18 illustrates embodiments of a first prefix 1601(A). In some embodiments, the first prefix 1601(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1601(A) may specify up to three registers using 3-bit fields depending on the format: 1) using the reg field 1744 and the R/M field 1746 of the Mod R/M byte 702; 2) using the Mod R/M byte 1702 with the SIB byte 1704 including using the reg field 1744 and the base field 1756 and index field 1754; or 3) using the register field of an opcode.

In the first prefix 1601(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 744 and MOD R/M R/M field 746 alone can each only address 8 registers.

In the first prefix 1601(A), bit position 2 (R) may an extension of the MOD R/M reg field 1744 and may be used to modify the ModR/M reg field 1744 when that field encodes a general purpose register, a 64-bit packed data register (e.g., a SSE register), or a control or debug register. R is ignored when Mod R/M byte 1702 specifies other registers or defines an extended opcode.

Bit position 1 (X) X bit may modify the SIB byte index field 1754.

Bit position B (B) B may modify the base in the Mod R/M R/M field 1746 or the SIB byte base field 1756; or it may modify the opcode register field used for accessing general purpose registers (e.g., general purpose registers 525).

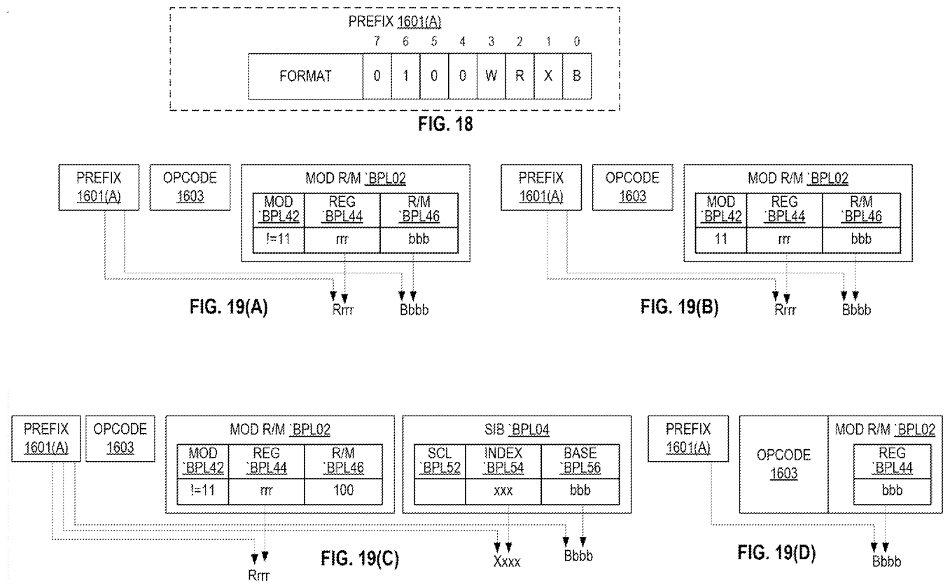

FIGS. 19(A)-(D) illustrate embodiments of how the R, X, and B fields of the first prefix 1601(A) are used. FIG. 19(A) illustrates R and B from the first prefix 1601(A) being used to extend the reg field 744 and R/M field 746 of the MOD R/M byte 702 when the SIB byte 704 is not used for memory addressing. FIG. 19(B) illustrates R and B from the first prefix 1601(A) being used to extend the reg field 744 and R/M field 746 of the MOD R/M byte 702 when the SIB byte 704 is not used (register-register addressing). FIG. 19(C) illustrates R, X, and B from the first prefix 1601(A) being used to extend the reg field 744 of the MOD R/M byte 702 and the index field 754 and base field 756 when the SIB byte 7 04 being used for memory addressing. FIG. 19(D) illustrates B from the first prefix 1601(A) being used to extend the reg field 744 of the MOD R/M byte 702 when a register is encoded in the opcode 603.

FIGS. 10(A)-(B) illustrate embodiments of a second prefix 601(B). In some embodiments, the second prefix 601(B) is an embodiment of a VEX prefix. The second prefix 601(B) encoding allows instructions to have more than two operands, and allows SIMD vector registers (e.g., vector/SIMD registers 510) to be longer than 64-bits (e.g., 128-bit and 256-bit). The use of the second prefix 601(B) provides for three-operand (or more) syntax. For example, previous two-operand instructions performed operations such as A=A+B, which overwrites a source operand. The use of the second prefix 601(B) enables operands to perform nondestructive operations such as A=B+C.

In some embodiments, the second prefix 601(B) comes in two forms-a two-byte form and a three-byte form. The two-byte second prefix 601(B) is used mainly for 128-bit, scalar, and some 256-bit instructions; while the three-byte second prefix 601(B) provides a compact replacement of the first prefix 601(A) and 3-byte opcode instructions.

FIG. 10(A) illustrates embodiments of a two-byte form of the second prefix 601(B). In one example, a format field 1001 (byte 0 1003) contains the value C5H. In one example, byte 1 1005 includes a “R” value in bit [7]. This value is the complement of the same value of the first prefix 601(A). Bit [2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746 and the Mod R/M reg field 744 encode three of the four operands. Bits[7:4] of the immediate 1609 are then used to encode the third source register operand.

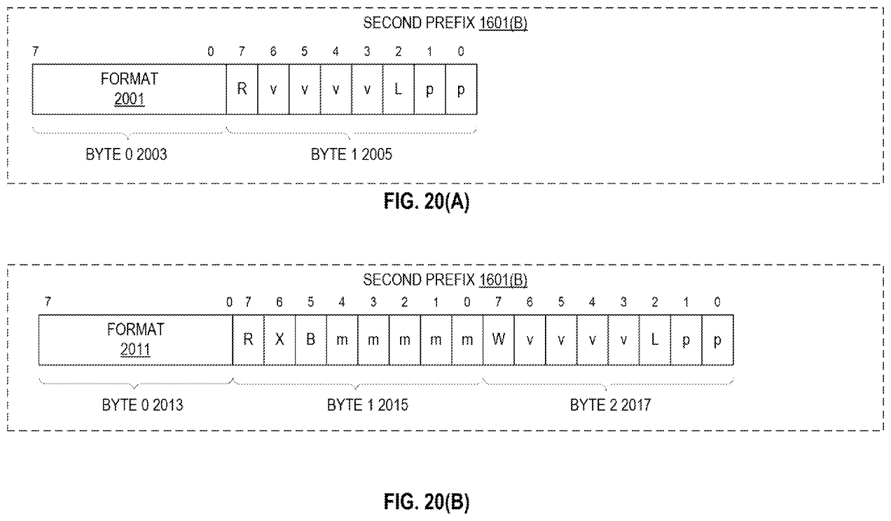

FIG. 20(B) illustrates embodiments of a three-byte form of the second prefix 601(B). in one example, a format field 2011 (byte 0 2013) contains the value C4H. Byte 1 2015 includes in bits [7:5] “R,” “X,” and “B” which are the complements of the same values of the first prefix 601(A). Bits[4:0] of byte 1 2015 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit [7] of byte 2 2017 is used similar to W of the first prefix 601(A) including helping to determine promotable operand sizes. Bit [2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746, and the Mod R/M reg field 744 encode three of the four operands. Bits[7:4] of the immediate 609 are then used to encode the third source register operand.

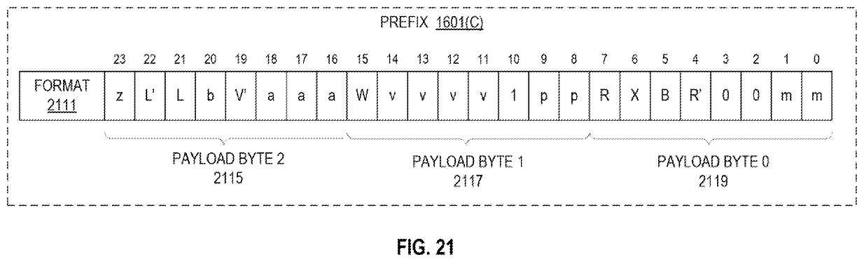

FIG. 21 illustrates embodiments of a third prefix 1601(C). In some embodiments, the first prefix 1601(A) is an embodiment of an EVEX prefix. The third prefix 1601(C) is a four-byte prefix.

The third prefix 1601(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 15) or predication utilize this prefix. Opmask register allow for conditional processing or selection control. Opmask instructions, whose source/destination operands are opmask registers and treat the content of an opmask register as a single value, are encoded using the second prefix 1601(B).

The third prefix 1601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1601(C) is a format field 2111 that has a value, in one example, of 62H. Subsequent bytes are referred to as payload bytes 2115, 2116, and 2119 and collectively form a 24-bit value of P[23:0] providing specific capability in the form of one or more fields (detailed herein).

In some embodiments, P[1:0] of payload byte 2119 are identical to the low two mmmmm bits. P[3:2] are reserved in some embodiments. Bit P[4] (R′) allows access to the high 16 vector register set when combined with P[7] and the ModR/M reg field 1744. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 1744 and ModR/M R/M field 1746. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 601(A) and second prefix 611(B) and may serve as an opcode extension bit or operand size promotion.

P[18:16] specify the index of a register in the opmask (writemask) registers (e.g., writemask/predicate registers 1515). In one embodiment of the invention, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in instructions using the third prefix 1601(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, | Destination or Source |
| | | | reg | Vector | |
| VVVV | V′ | vvvv | | GPR, | 2nd Source or |
| | | | | Vector | Destination |
| RM | X | B | ModR/M | GPR, | 1st Source or |
| | | | R/M | Vector | Destination |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

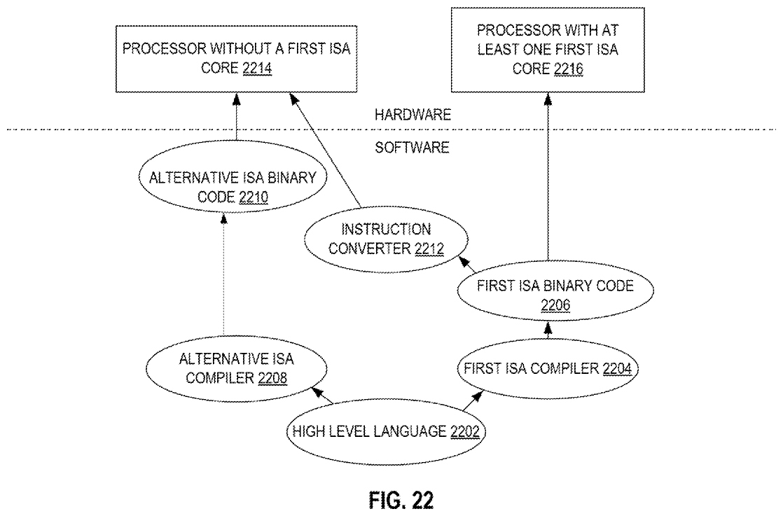

FIG. 22 illustrates a block diagram contrasting the use of a software instruction converter to convert binary instructions in a source instruction set to binary instructions in a target instruction set according to certain implementations. In the illustrated embodiment, the instruction converter is a software instruction converter, although alternatively the instruction converter may be implemented in software, firmware, hardware, or various combinations thereof. FIG. 22 shows a program in a high level language 2202 may be compiled using a first ISA compiler 2204 to generate first ISA binary code 2206 that may be natively executed by a processor with at least one first instruction set core 2216. The processor with at least one first ISA instruction set core 2216 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 2204 represents a compiler that is operable to generate first ISA a binary code 2206 (e.g., object code) that can, with or without additional linkage processing, be executed on the processor with at least one first ISA instruction set core 2216.

Similarly, FIG. 22 shows the program in the high level language 2202 may be compiled using an alternative instruction set compiler 2208 to generate alternative instruction set binary code 2210 that may be natively executed by a processor without a first ISA instruction set core 2214. The instruction converter 2212 is used to convert the first ISA binary code 2206 into code that may be natively executed by the processor without a first ISA instruction set core 2214. This converted code is not likely to be the same as the alternative instruction set binary code 2210 because an instruction converter capable of this is difficult to make; however, the converted code will accomplish the general operation and be made up of instructions from the alternative instruction set. Thus, the instruction converter 2212 represents software, firmware, hardware, or a combination thereof that, through emulation, simulation or any other process, allows a processor or other electronic device that does not have a first ISA instruction set processor or core to execute the first ISA binary code 2206.

### EXAMPLES

The following are example implementations of different embodiments of the invention.

Example 1. A processor, comprising: a plurality of cores to execute instructions; a memory controller coupled to the plurality of cores, the memory controller operable in a first error correction mode and a second error correction mode, the memory controller comprising: a decoder to decode first error correction code (ECC) bits encoded in accordance with the first error correction mode to determine a first syndrome and a second syndrome based on data corresponding to the ECC bits; error detection circuitry to determine whether one or both of the first syndrome and the second syndrome indicates an error in the data; and an encoder to generate second ECC bits in accordance with the second error correction mode, the ECC bits to be encoded based on whether one or both of the first syndrome and the second syndrome indicates an error.

Example 2. The processor of example 1, wherein the data comprises one or more cachelines, the cachelines to be read in pairs from two ranks of a memory device and decoded by the decoder, the cachelines to be encoded by the encoder and split over the two ranks.

Example 3. The processor of examples 1 or 2 wherein if the first and second syndromes both indicate no error, then the encoder is to set a trusted execution bit indicating that the data is associated with a trusted execution environment based on values of the first and second syndromes.

Example 4. The processor of any of examples of 1 to 3 wherein if both the first and second syndromes indicate an uncorrectable error, then the encoder is to poison a cacheline associated with the data.

Example 5. The processor of any of examples 1 to 4 wherein if one of the first syndrome or the second syndrome indicates a correctable error, then the data is to be corrected using the one of the first syndrome or the second syndrome which indicated the correctable error, and the trusted execution bit is set based on which of the first and second syndromes indicated the correctable error.

Example 6. The processor of any of examples of 1 to 5 wherein if both the first syndrome and the second syndrome indicate a correctable error, then the encoder is to generate a set of metadata bits usable on a read operation to identify whether the data is associated with a trusted execution environment.

Example 7. The processor of any of examples 1 to 6 wherein if both the first syndrome and the second syndrome indicate a correctable error, the encoder is to generate the second ECC bits based on the data and the set of metadata bits and to store the second ECC bits with the data and the set of metadata bits.

Example 8. The processor of any examples of 1 to 7 wherein in response to a read operation, the memory controller is to use the set of metadata to determine a corresponding syndrome to perform error correction.

Example 9. A method comprising: executing instructions on a plurality of cores, the plurality of cores coupled to a memory controller operable in a first error correction mode and a second error correction mode; decoding first error correction code (ECC) bits encoded in accordance with the first error correction mode to determine a first syndrome and a second syndrome based on data corresponding to the ECC bits; determining whether one or both of the first syndrome and the second syndrome indicates an error in the data; and generating second ECC bits in accordance with the second error correction mode, the ECC bits to be encoded based on whether one or both of the first syndrome and the second syndrome indicates an error.

Example 10. The method of example 9, wherein the data comprises one or more cachelines, the cachelines to be read in pairs from two ranks of a memory device and decoded by the decoder, the cachelines to be encoded by the encoder and split over the two ranks.

Example 11. The method of examples 9 or 10 wherein if the first and second syndromes both indicate no error, then setting a trusted execution bit indicating that the data is associated with a trusted execution environment based on values of the first and second syndromes.

Example 12. The method of any of examples 9 to 11 wherein if both the first and second syndromes indicate an uncorrectable error, then poisoning a cacheline associated with the data.

Example 13. The method of any of examples of 9 to 12 wherein if one of the first syndrome or the second syndrome indicates a correctable error, then correcting the data using the one of the first syndrome or the second syndrome which indicated the correctable error, and setting the trusted execution bit based on which of the first and second syndromes indicated the correctable error.

Example 14. The method of any of examples 9 to 13 wherein if both the first syndrome and the second syndrome indicate a correctable error, then generating a set of metadata bits usable on a read operation to identify whether the data is associated with a trusted execution environment.

Example 15. The method of any of examples 9 to 14 wherein if both the first syndrome and the second syndrome indicate a correctable error, then generating the second ECC bits based on the data and the set of metadata bits and to store the second ECC bits with the data and the set of metadata bits.

Example 16. The method of any of examples 9 to 15 wherein in response to a read operation, determining a corresponding syndrome to perform error correction based on the set of metadata.

Example 17. At least one machine readable medium having program code stored thereon which, when executed by a processor, causes the processor to perform operations comprising: executing instructions on a plurality of cores, the plurality of cores coupled to a memory controller operable in a first error correction mode and a second error correction mode; decoding first error correction code (ECC) bits encoded in accordance with the first error correction mode to determine a first syndrome and a second syndrome based on data corresponding to the ECC bits; determining whether one or both of the first syndrome and the second syndrome indicates an error in the data; and generating second ECC bits in accordance with the second error correction mode, the ECC bits to be encoded based on whether one or both of the first syndrome and the second syndrome indicates an error.

Example 18. The machine-readable medium of example 17, wherein the data comprises one or more cachelines, the cachelines to be read in pairs from two ranks of a memory device and decoded by the decoder, the cachelines to be encoded by the ecoder and split over the two ranks.

Example 19. The machine-readable medium of examples 17 or 18 wherein if the first and second syndromes both indicate no error, then setting a trusted execution bit indicating that the data is associated with a trusted execution environment based on values of the first and second syndromes.

Example 20. The machine-readable medium of any of examples 17 to 19 wherein if both the first and second syndromes indicate an uncorrectable error, then poisoning a cacheline associated with the data.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device.

One or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
a plurality of cores to execute instructions;
a memory controller coupled to the plurality of cores, the memory controller operable in a first error correction mode and a second error correction mode, the memory controller comprising:
a decoder to decode first error correction code (ECC) bits encoded in accordance with the first error correction mode to determine a first syndrome and a second syndrome based on data corresponding to the ECC bits;
error detection circuitry to determine whether one or both of the first syndrome and the second syndrome indicates an error in the data; and
an encoder to generate second ECC bits in accordance with the second error correction mode, the ECC bits to be encoded based on whether one or both of the first syndrome and the second syndrome indicates an error.

2. The processor of claim 1, wherein the data comprises one or more cachelines, the cachelines to be read in pairs from two ranks of a memory device and decoded by the decoder, the cachelines to be encoded by the encoder and split over the two ranks.

3. The processor of claim 1 wherein if the first and second syndromes both indicate no error, then the encoder is to set a trusted execution bit indicating that the data is associated with a trusted execution environment based on values of the first and second syndromes.

4. The processor of claim 3 wherein if both the first and second syndromes indicate an uncorrectable error, then the encoder is to poison a cacheline associated with the data.

5. The processor of claim 4 wherein if one of the first syndrome or the second syndrome indicates a correctable error, then the data is to be corrected using the one of the first syndrome or the second syndrome which indicated the correctable error, and the trusted execution bit is set based on which of the first and second syndromes indicated the correctable error.

6. The processor of claim 1 wherein if both the first syndrome and the second syndrome indicate a correctable error, then the encoder is to generate a set of metadata bits usable on a read operation to identify whether the data is associated with a trusted execution environment.

7. The processor of claim 6 wherein if both the first syndrome and the second syndrome indicate a correctable error, the encoder is to generate the second ECC bits based on the data and the set of metadata bits and to store the second ECC bits with the data and the set of metadata bits.

8. The processor of claim 7 wherein in response to a read operation, the memory controller is to use the set of metadata to determine a corresponding syndrome to perform error correction.

9. A method comprising:
executing instructions on a plurality of cores, the plurality of cores coupled to a memory controller operable in a first error correction mode and a second error correction mode;
decoding first error correction code (ECC) bits encoded in accordance with the first error correction mode to determine a first syndrome and a second syndrome based on data corresponding to the ECC bits;
determining whether one or both of the first syndrome and the second syndrome indicates an error in the data; and
generating second ECC bits in accordance with the second error correction mode, the ECC bits to be encoded based on whether one or both of the first syndrome and the second syndrome indicates an error.

10. The method of claim 9, wherein the data comprises one or more cachelines, the cachelines to be read in pairs from two ranks of a memory device and decoded by the decoder, the cachelines to be encoded by the encoder and split over the two ranks.

11. The method of claim 9 wherein if the first and second syndromes both indicate no error, then setting a trusted execution bit indicating that the data is associated with a trusted execution environment based on values of the first and second syndromes.

12. The method of claim 11 wherein if both the first and second syndromes indicate an uncorrectable error, then poisoning a cacheline associated with the data.

13. The method of claim 12 wherein if one of the first syndrome or the second syndrome indicates a correctable error, then correcting the data using the one of the first syndrome or the second syndrome which indicated the correctable error, and setting the trusted execution bit based on which of the first and second syndromes indicated the correctable error.

14. The method of claim 9 wherein if both the first syndrome and the second syndrome indicate a correctable error, then generating a set of metadata bits usable on a read operation to identify whether the data is associated with a trusted execution environment.

15. The method of claim 14 wherein if both the first syndrome and the second syndrome indicate a correctable error, then generating the second ECC bits based on the data and the set of metadata bits and to store the second ECC bits with the data and the set of metadata bits.

16. The method of claim 15 wherein in response to a read operation, determining a corresponding syndrome to perform error correction based on the set of metadata.

17. At least one machine readable medium having program code stored thereon which, when executed by a processor, causes the processor to perform operations comprising:
executing instructions on a plurality of cores, the plurality of cores coupled to a memory controller operable in a first error correction mode and a second error correction mode;
decoding first error correction code (ECC) bits encoded in accordance with the first error correction mode to determine a first syndrome and a second syndrome based on data corresponding to the ECC bits;
determining whether one or both of the first syndrome and the second syndrome indicates an error in the data; and
generating second ECC bits in accordance with the second error correction mode, the ECC bits to be encoded based on whether one or both of the first syndrome and the second syndrome indicates an error.

18. The machine-readable medium of claim 17, wherein the data comprises one or more cachelines, the cachelines to be read in pairs from two ranks of a memory device and decoded by the decoder, the cachelines to be encoded by the encoder and split over the two ranks.

19. The machine-readable medium of claim 17 wherein if the first and second syndromes both indicate no error, then setting a trusted execution bit indicating that the data is associated with a trusted execution environment based on values of the first and second syndromes.

20. The machine-readable medium of claim 19 wherein if both the first and second syndromes indicate an uncorrectable error, then poisoning a cacheline associated with the data.
